(19) United States
(12) Patent Application Publication
(10) Pub. No.: US 2024/0375306 A1
(43) Pub. Date: Nov. 14, 2024

(54) SYSTEM AND METHOD FOR COATING A BLADE

(71) Applicant: Edgewell Personal Care Brands, LLC, Chesterfield, MO (US)

(72) Inventors: Jochen Thoene, Wuppertal (DE); Sandra Becker, Solingen (DE)

(21) Appl. No.: 18/683,998

(22) PCT Filed: Aug. 11, 2022
(86) PCT No.: PCT/US22/74806

§ 371 Date: Feb. 15, 2024

Related U.S. Application Data
(60) Provisional application No. 63/236,278, filed on Aug. 24, 2021.

(51) Int. Cl. B26D 1/00; B05D 1/00; B05D 3/02; B05D 5/08; B05D 7/14; B26B 21/60

(52) U.S. Cl. CPC B26D 1/0006; B05D 1/62; B05D 3/0254; B05D 5/083; B05D 7/14; B26B 21/60; B05D 2202/15; B26D 2001/002

(57) ABSTRACT

A method of applying a lubricious coating of a material such as a fluoropolymer to a cutting edge of a blade includes providing the blade having the cutting edge including a tip end, a first facet, and a second facet with the first facet and the second facet adjacent the tip end. The method further includes generating a plasma stream and directing the plasma stream towards the cutting edge. The method further includes introducing a fluid stream containing a dispersion including the fluoropolymer into the plasma stream, thereby simultaneously plasma treating the cutting edge and depositing solids of the dispersion onto the cutting edge.

### BACKGROUND

### 1. Technical Field

The present disclosure relates to blades in general and, more particularly, to methods of applying a lubricious coating to cutting edges of razor blades.

### 2. Background

Some blades, and especially razor blades, are typically made of a suitable substrate material such as stainless steel, and a cutting edge is formed with a wedge-shaped configuration with a tip end and adjacent facets. Hard coatings such as diamond, amorphous diamond, diamond-like carbon (DLC) material, metals, nitrides, carbides, oxides or ceramics are often used to improve strength, corrosion resistance and shaving ability, and to maintain required strength while permitting thinner edges which may allow reduced cutting forces to be used during shaving.

It is known from the art, for instance from U.S. Pat. Nos. 3,743,551 and 3,838,512, that the shaving properties of a razor blade can be improved by applying a lubricious polymer outer surface coating (e.g., a fluoropolymer such as polytetrafluoroethylene-“PTFE”). Typically, polymer coatings of this type are applied to create a relatively thin layer (e.g., equal to or less than 500 nm thick) on at least the tip of the blade and preferably extending onto the facets. The layer can be applied using a variety of different techniques: e.g., spray application, bath dipping, etc. Spray application of PTFE coating materials may require relatively large quantities of expensive PTFE material to be used because not all of the PTFE material will bond to the razor blade. It is further disclosed that since no application process will apply a perfectly uniform layer thickness across the entire desired surface, the thickness of the initially applied layer is typically chosen to ensure adequate layer thickness given an expected thickness variation.

Although this “relatively” thin layer ensures adequate layer thickness, it is not optimum for shaving, i.e., it is too thick. During the first few strokes of use of a new coated blade, a portion of the polymer coating (if left at the initial thickness) will be removed from the tip as a result of the shaving process by the user of the blade. This process of moving the surface coating is sometimes referred to as “push back” or “peel back” of the coating. After the excess polymer coating is “pushed back” from the user applying the blade during shaving, a much thinner layer of polymer coating (a layer that can be one polymer molecule thick) typically remains on the blade edge throughout the useful life of the blade. However, until the initial thickness of the polymer coating is “pushed back,” the user can experience some amount of discomfort, known as the First Shave Effect.

Attempts have been disclosed to provide a thinner coating to preempt user push back and avoid this initial discomfort. U.S. Pat. Nos. 5,985,459, 7,247,249, and 10,766,157 disclose methods of treating a razor blade cutting edge having an adherent polyfluorocarbon (fluoropolymer) coating with a solvent to partially remove some of an initially thicker coating, apparently to potentially avoid the aforesaid discomfort associated with the excessively thick coating. Using a solvent can significantly add to the blade manufacturing cost, and in some instances add additional manufacturing steps. U.S. Patent application publication 2020/0353054 and International Patent Application publication WO2020/043476 disclose methods of physically contacting the initially thicker adherent coating to mechanically remove a portion thereof. Again, this is an undesirable additional manufacturing step, and physical contact to a cutting edge may increase the probability of damage to the cutting edge during the manufacturing (coating removal) process. Further additional partial physical removal manufacturing steps are disclosed in U.S. Pat. Nos. 9,943,879 and 9,969,094. Commonly assigned International Patent Application WO2020/081763 discloses a method of initially applying a thinner fluoropolymer coating to a cutting edge, to attempt to beneficially avoiding post-application thinning operations. However, the coating thickness by this method is not as thin as is truly desirable, i.e., a thickness approaching the thickness of a single polymer molecule.

### SUMMARY

The present disclosure has for its objective to substantially alleviate the limitations of the prior art systems and methods for coating blades. The disclosure is for a method of applying a coating of a lubricious material such as a fluoropolymer to a cutting edge of a blade and a coating system to provide the same. A blade is provided having a cutting edge including a tip end, a first and a second facet, both facets being adjacent the tip end. A plasma stream is generated and directed towards the cutting edge. A fluid stream containing a dispersion including the fluoropolymer is introduced into the plasma stream, thereby simultaneously plasma treating the cutting edge and depositing solids of the dispersion onto the cutting edge.

In some aspects the method further sinters the blade to cause the deposited solids to form the coating of the fluoropolymer on the cutting edge.

In some aspects the cutting edge defines a center plane, the system and method further include positioning a plasma nozzle generally at the center plane and generating the plasma stream with the plasma nozzle such that the plasma stream is directed along the center plane. In other aspects the cutting edge defines a center plane, the system and method further include positioning a plasma nozzle so that the plasma nozzle is angularly offset from the center plane and generating the plasma stream with the plasma nozzle such that the plasma stream is directed towards the first facet. In further aspects of the preceding aspect a second plasma nozzle is positioned so that the second plasma nozzle is angularly offset from the center plane and opposite the center plane from the plasma nozzle and generating a second plasma stream with the second plasma nozzle such that the second plasma stream of the second plasma nozzle is directed towards the second facet.

In some aspects the fluoropolymer is polytetrafluoroethylene.

In some aspects the dispersion is an aqueous dispersion and solids of the polytetrafluoroethylene comprise between 1% and 2% of the dispersion.

In some aspects the plasma is atmospheric plasma.

In some aspects the blade is a razor blade.

The above features and advantages as further described will be more fully understood with reference to the following detailed description when taken in conjunction with the accompanying drawings.

### BRIEF DESCRIPTION OF THE DRAWINGS

FIG. 1 is a planar front view of a razor assembly including a razor cartridge and a handle.

FIG. 2 is a planar top view of the razor cartridge of FIG. 1.

FIG. 3 is a planar top view of an exemplary razor blade for the razor cartridge of FIG. 1.

FIG. 4 is a planar side view of the exemplary razor blade of FIG. 4.

FIG. 5 is a diagrammatic illustration of a razor blade cutting edge including a coating.

FIG. 6 is a diagrammatic planar side view of an exemplary blade coating system.

FIG. 7 is a diagrammatic planar side view of another exemplary blade coating system.

FIG. 8 illustrates a flow chart for a method of applying a coating of a fluoropolymer to a cutting edge of a blade.

FIG. 9 is a planar top view of fixture holding a plurality of razor blades.

FIG. 10 is a side, cross-sectional view of the fixture of FIG. 9.

FIG. 11 is a planar top view of a coiled razor blade ribbon.

### DETAILED DESCRIPTION

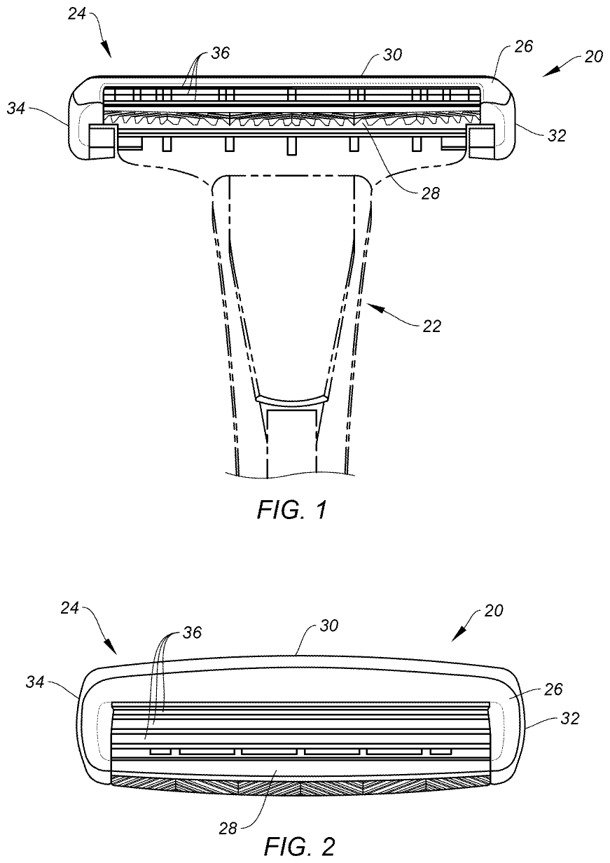

Aspects of the present disclosure include a system and method for applying a lubricious coating of a material such as a fluoropolymer to a cutting edge of a blade. Non-limiting examples of blades may include razor blades (e.g., a razor blade for shaving), which may be used individually or as part of a larger system, such as a razor cartridge. Referring to FIGS. 1 and 2, an exemplary razor cartridge 20 for use in a shaving process is shown to facilitate the description provided herein, however, the present disclosure is not limited to this particular razor cartridge embodiment. The razor cartridge 20 is rigidly or pivotally mounted to a handle 22. In some embodiments, the razor cartridge 20 may be a disposable portion of a razor assembly 24 which is detachable from a reusable handle 22. In some other embodiments, the razor cartridge 20 and the handle 22 may be combined into a unitary disposable razor assembly 24.

The razor cartridge 20 includes a body 26 having a forward portion 28, an aft portion 30, a first lateral portion 32, and a second lateral portion 34. Each of the first lateral portion 32 and the second lateral portion 34 extend between the forward portion 28 and the aft portion 30. The razor cartridge 20 further includes at least one razor blade 36 mounted within the body 26. The razor blades 36 are disposed aft of the forward portion 28 and forward of the aft portion 30. The razor blades 36 are disposed laterally between the first lateral portion 32 and the second lateral portion 34. The terms “forward” and “aft” as used herein are defined in terms of the orientation in which a razor blade 36 encounters a user's skin when the razor cartridge 20 is used in a conventional manner, e.g., the razor blades 36 will move in a direction from forward to aft relative to a point on the user's skin.

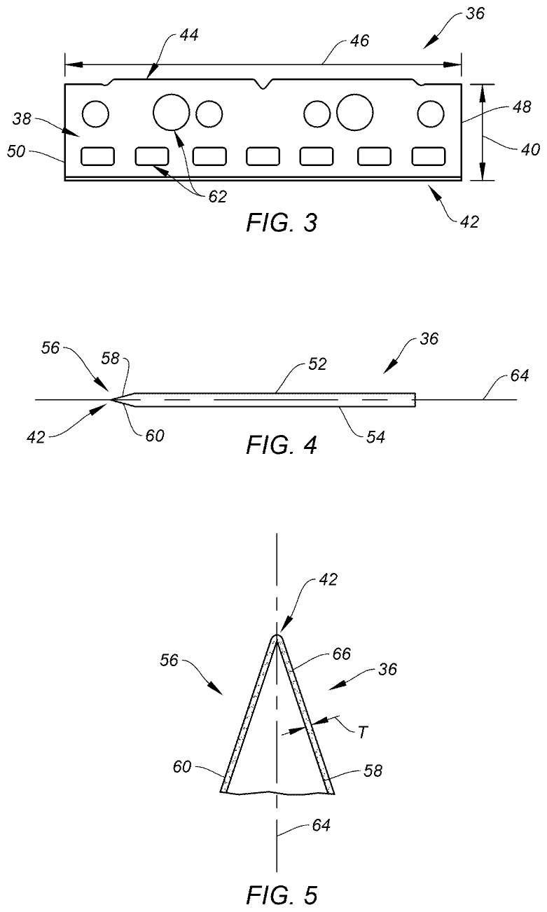

Referring to FIGS. 3-5, the razor blade 36 according to the present disclosure can assume a variety of configurations, each including a body 38 having a width 40 extending between a tip end 42 and an aft end 44, and a length 46 extending between a first lateral end 48 and a second lateral end 50. The body 38 further includes an upper body surface 52 and a lower body surface 54, which body surfaces 52, 54 extend widthwise between the tip end 42 and the aft end 44, and lengthwise between the first lateral end 48 and the second lateral end 50. As shown in FIG. 5, the razor blade 36 includes a lengthwise extending cutting edge 56 which includes the tip end 42, a first facet 58, and a second facet 60, where the first facet 58 and the second facet 60 are adjacent the tip end 42. The first facet 58 and the second facet 60 converge at the tip end 42 and extend aftward to the respective upper body surface 52 and lower body surface 54. The razor blade 36 includes a center plane 64 extending widthwise through the body 38 of the razor blade 36. The cutting edge 56 may be oriented along the center plane 64 as shown, for example, in FIGS. 4 and 5. However, the present disclosure is not limited to this particular orientation of the cutting edge 56 and, in various embodiments, the cutting edge 56 may be positioned outside (e.g., to one side of) the center plane 64 of the razor blade 36. As will be discussed in further detail, the razor blade 36 may include one or more apertures 62 configured to function allow a plurality of the razor blades 36 to be mounted together during manufacturing, for example, within a cartridge. Additionally, or alternatively, the one or more apertures may be configured wash-through ports to facilitate removal of shaving debris. The description of the razor blade 36 provided herein is included to facilitate understanding of the present disclosure, however, the present disclosure is not limited to this particular razor blade embodiment.

The razor blade 36 may generally be made from a stainless-steel material. In various embodiments, the razor blade 36 may include a coating including one or more materials such as diamond, amorphous diamond, diamond-like carbon (DLC) materials, metals, nitrides, carbides, oxides, ceramics, or the like, to improve one or more of the strength, corrosion resistance, and shaving ability of the razor blade 36. The present disclosure is not limited to any particular material or combination of materials for the razor blade 36.

The razor blade 36 includes a lubricious outer coating 66 disposed on the cutting edge 56 of the razor blade 36. For example, the coating 66 may be disposed on all or a portion of the tip end 42, the first facet 58, and the second facet 60 of the cutting edge 56 and may additionally be disposed on portions of the upper body surface 52 and lower body surface 54 as well. The coating 66 has a thickness T. In various embodiments, the thickness T of the coating 66 may be substantially constant along the cutting edge 56, while in other embodiments the thickness T of the coating 66 may vary at different locations along the cutting edge 56.

The coating 66 according to the present disclosure may include, but is not limited to, a fluoropolymer material. A particularly useful fluoropolymer material for the coating 66 material is polytetrafluoroethylene (“PTFE”). Other non-limiting examples of coating 66 materials include silicons such as organosiloxane gel, polyethers, etc. The present disclosure is not limited to using any particular type of coating 66 material providing the material can be processed in the manner described below. To facilitate the description of the systems and methods of the present disclosure, the coating 66 material will be discussed as being PTFE. As indicated above, however, the present disclosure is not limited to use with PTFE-type coating 66 materials.

Referring to FIGS. 5-7, the present disclosure includes a blade coating system 68 configured for applying the coating 66 to the cutting edge 56 of the razor blade 36. The blade coating system 68 includes at least one plasma generator 70. The plasma generator 70 includes a plasma nozzle 72 configured to direct a plasma stream 74 outwardly therefrom along a plasma stream axis 76. In the schematic figures, the plasma generator 70 is depicted as being unitary with the plasma nozzle 72. However, in some executions of the present disclosure, these can be separate i.e. the plasma generator 70 can be connected to the plasma nozzle 72 by a suitable conduit to enable the plasma to travel to the plasma nozzle 72. The plasma generator 70 may be configured to generate an atmospheric-pressure plasma. As used herein, the term “atmospheric-pressure plasma” refers to a plasma generated from ambient air and having a pressure which is approximately the same as the pressure of the surrounding atmosphere and can be contrasted with “low-pressure” or “high-pressure” plasmas which may require the use of a pressure vessel (e.g., a “reaction vessel”) to maintain the plasma pressure above that of the surrounding atmosphere. For example, the plasma stream 74 may exit the plasma nozzle 72 with a pressure of approximately 4-6 bar. Atmospheric-pressure plasmas may be generated by various plasma nozzle configurations such as, for example, an arc discharge or a corona discharge configuration, and the present disclosure is not limited to any particular plasma nozzle configuration.

The blade coating system 68 includes at least one spray nozzle 78 configured to discharge a fluid stream 80 outwardly therefrom along a fluid stream axis 82. The spray nozzle 78 is positioned relative to the plasma nozzle 72 so that the fluid stream axis 82 intersects the plasma stream axis 76 at an angle A1 e.g. an acute angle, preferably in a range 30-50 degrees at a position axially downstream from the plasma nozzle 72 with respect to the plasma stream axis 76. The fluid stream 80 should not be wider than the plasma stream 74. The spray nozzle 78 is positioned a distance D1 from the plasma stream axis 76 along the fluid stream axis 82. In various embodiments, the spray nozzle 78 may be mounted to the plasma generator 70 as shown, for example, in FIG. 7. However, the present disclosure is not limited to any particular means for positioning the spray nozzle 78 relative to the plasma generator 70.

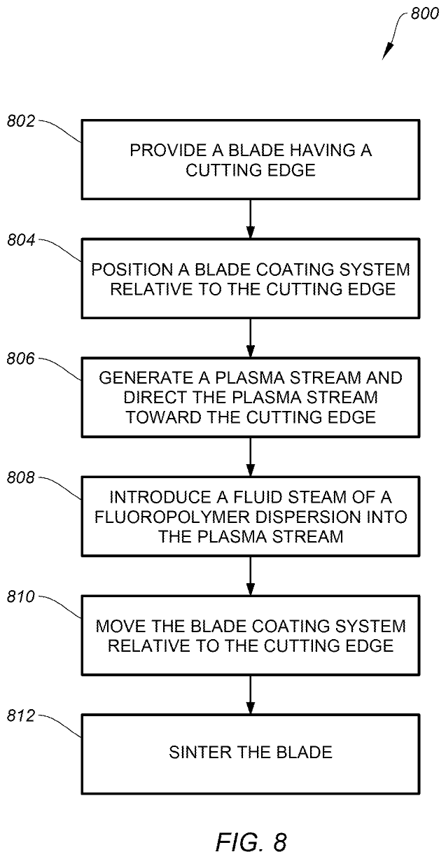

In various embodiments, the blade coating system 68 may include a plurality of plasma nozzles 70 such as a first plasma generator 70A and a second plasma generator 70B. The blade coating system 68 may also include a respective plurality of spray nozzles 78 such as a first spray nozzle 78A and a second spray nozzle 78B. Each spray nozzle 78, 78A, 78B may be mounted to or otherwise positioned relative to a respective plasma generator 70, 70A, 70B as described above and shown in FIG. 8.

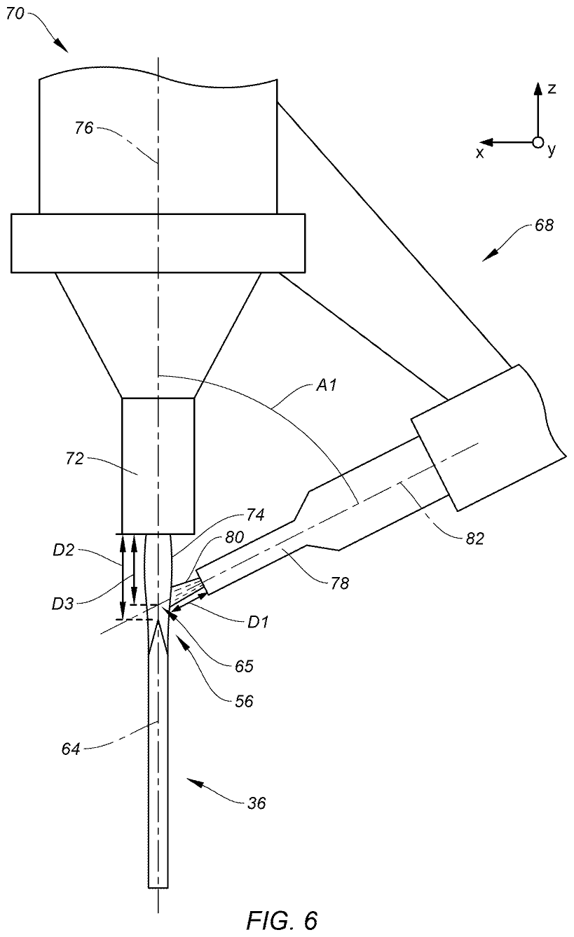

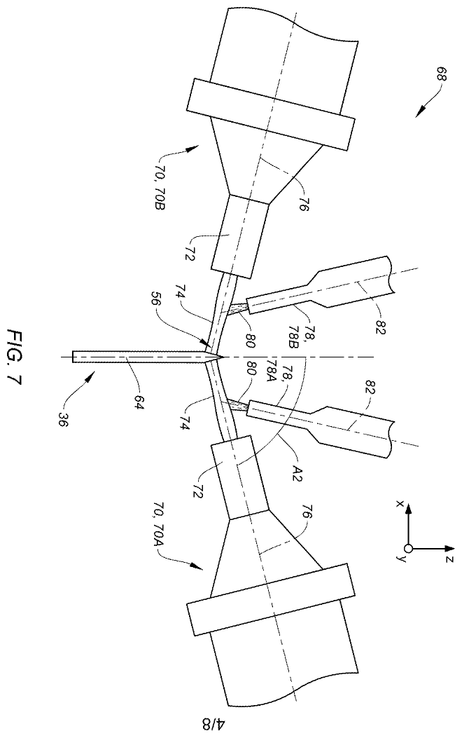

Referring to FIGS. 3-11, the present disclosure includes a method 800 for applying a coating of a fluoropolymer to a cutting edge of a blade, as shown in the flow chart illustrated in FIG. 8. For case of description, the method 800 is described below with reference to the blade coating system 68 of FIGS. 6 and 7 and the razor blade 36 of FIGS. 3-5. The method 800, however, may alternatively be performed for other blades and with other blade coating systems.

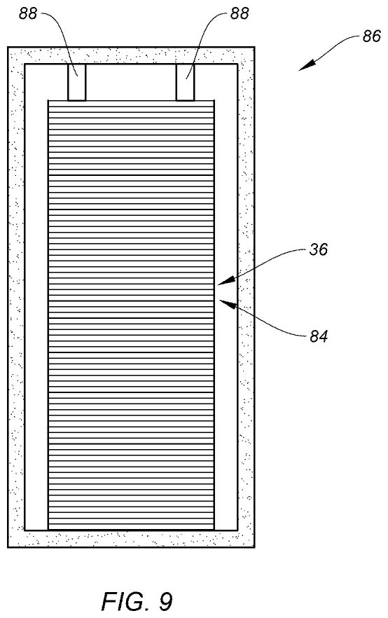

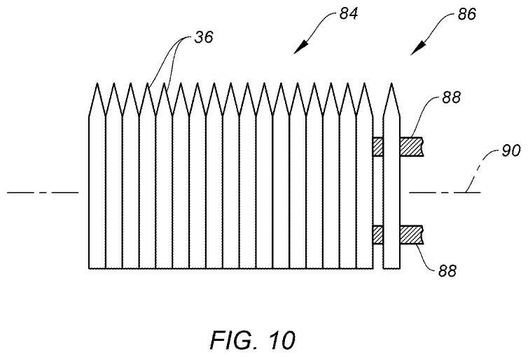

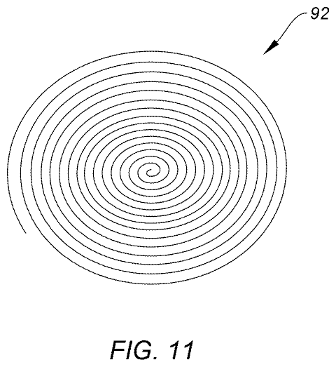

In step 802, the razor blades 36 are provided in preparation for applying the coating 66 to the cutting edges 56 of the respective razor blades 36. In various embodiments, the razor blades 36 to be coated may each be individual razor blades. In various other embodiments, the razor blades 36 to be coated may not yet be in individual form. As shown in FIGS. 9 and 10, in various embodiments, step 802 may include mounting a plurality of the razor blades 36 as a stack 84 within a fixture 86. Mounting the razor blades 36 within the fixture 86 allows the razor blades 36 to be stacked with the same orientation and with the cutting edges 56 of the razor blades 36 exposed. The fixture 86 may include one or more blade retaining members 88 which extend through apertures (e.g., apertures 62) of the razor blades 36 to retain the razor blades 36 within the fixture 86 but allow the razor blades 36 to move relative to one another along a stack axis 90. As shown in FIG. 11, in various embodiments, a plurality of the razor blades 36 may be arranged as an integral razor blade ribbon 92, where the ribbon 92 is coiled. The ribbon 92 may subsequently be cut or otherwise processed to form a plurality of razor blades 36. The present disclosure is not limited to any particular arrangement of the razor blades 36 in preparation for applying the coating 66. The razor blades 36 are coated in ambient conditions, i.e. the blades 36 are not necessarily coated in any (low, medium, high) vacuum chamber or other pressure vessel.

In step 804, the blade coating system 68 is positioned relative to the razor blade 36. For example, the blade coating system 68 may be positioned relative to an individual razor blade or relative to a plurality of the razor blades 36 configured, for example, as the coiled ribbon 92. The blade coating system 68 may be positioned so that the plasma nozzle 72 is positioned a distance D2 from the tip end 42 of the cutting edge 56 of the razor blade 36. The fluid stream axis 82 intersects the plasma stream axis 76 at intersection 65. The spray nozzle 78 is then positioned relative to the plasma nozzle 72 such that intersection 65 is a distance D3 from the plasma nozzle 72. As shown in FIG. 6, in various embodiments, the blade coating system 68 may be positioned so that the plasma nozzle 72 is positioned generally along the center plane 64 of the razor blade 36, such that the plasma stream 74 may be directed towards the cutting edge 56 along the center plane 64. For example, the plasma stream axis 76 of the plasma nozzle 72 may be aligned with and substantially parallel to the center plane 64 of the razor blade 36.

As shown in FIG. 7, in various embodiments, the blade coating system 68 may be positioned so that the plasma nozzle 72 is positioned angularly offset from the center plane 64 of the razor blade 36. For example, the plasma stream axis 76 of the plasma nozzle 72 may form an angle A2 relative to the center plane 64 of the razor blade 36. The plasma nozzle 72 may be positioned to direct the plasma stream 74 towards one of the first facet 58 or the second facet 60. For example, the plasma nozzle 72 may be positioned so that the plasma stream axis 76 is substantially perpendicular to a surface of one of the first facet 58 or the second facet 60. In embodiments of the blade coating system 68 having a first plasma nozzle 72A and a second plasma nozzle 72B, the first plasma generator 72A may be directed towards the first facet 58 while the second plasma generator 72B may be directed towards the second facet 60 and positioned opposite the center plane 64 from the first plasma generator 72A, as shown in FIG. 7. As used herein, the term “substantially” with regard to an angular relationship refers to the noted angular relationship+/−10 degrees.

In Step 806, the plasma nozzle 72 generates a stream of plasma 74 and the plasma stream 74 is directed towards the cutting edge 56 of the razor blade 36 so that the plasma stream 74 contacts the cutting edge 56. A working gas such as compressed air or other common industrial gases such as hydrogen, nitrogen, and/or oxygen is supplied to the plasma generator 70. By application of a high-voltage electric discharge, the plasma generator 70 produces a highly reactive atmospheric plasma from the working gas and discharges the plasma from the plasma nozzle 72 as the plasma stream 74.

In various embodiments, the cutting edge 56 of each razor blade 36 may be pretreated to improve bonding between the coating 66 material and the cutting edge 56. An example of how the cutting edge 56 may be pretreated includes applying the plasma stream 74 to the cutting edge 56 in preparation for deposition of the coating 66 material on the cutting edge 56. The chemical and physical interaction of the plasma stream 74 with the material of the razor blades 36 at the cutting edge 56 may increase the surface energy of the razor blade 36 material at the cutting edge 56. Additionally, the plasma stream 74 may remove all or a portion of oxide layers, dust deposits, grease, oil, and/or other contaminants from the cutting edge 56 which might otherwise interfere with bonding between the coating 66 material and the cutting edge 56. The present disclosure is not limited to plasma pretreatment of the cutting edge 56 and other pretreatment methods such as chemical pretreatment may be used.

In Step 808, the fluid stream 80 is introduced into the plasma stream 74 in order to deposit the coating 66 material on the cutting edge 56 of the razor blade 36. The fluid stream 80 is introduced into the plasma stream 74 by the spray nozzle 78 along the fluid stream axis 82 which intersects the plasma stream axis 76 between the plasma nozzle 72 and the cutting edge 56. The distance D1 between the spray nozzle 78 and the plasma stream axis 76 may be selected so that all or substantially all of the fluid stream 80 is introduced into and carried by the plasma stream 74.

In various embodiments, the fluid stream 80 includes a dispersion containing a fluoropolymer material which will be deposited on the cutting edge 56 of the razor blade 36 to form the coating 66. In various embodiments, the dispersion may be an aqueous dispersion including solids of the fluoropolymer material, such as PTFE. In various embodiments, solids of PTFE may be less than five percent of the dispersion or, more preferably, between approximately one percent and two percent of the dispersion, inclusive. One non-limiting example of a suitable fluoropolymer dispersion is DYNEON PTFE dispersion TF 5070GZ manufactured by 3M, which is a dispersion of PTFE in water, having a solids content of 50 percent. Another non-limiting example of a suitable fluoropolymer dispersion is DRYFILM LW-2120 manufactured by CHEMOURS, which is a dispersion of PTFE in water, having a solids content of 20 percent. Fluoropolymer dispersions, such as the aforementioned exemplary fluoropolymer dispersions, may be further diluted (e.g., with water) to obtain the desired solids content of PTFE. In various embodiments, the dispersion may further include a surfactant or “wetting agent.” One non-limiting example of a suitable wetting agent is TIONOX 465 manufactured by PIGMENTSOLUTION GmbH. In further embodiments when the coating is a non-fluorinated material such as a siloxane as previously mentioned, the siloxane can be in the form of a solution rather than a dispersion.

Once introduced by the fluid stream 80 into the plasma stream 74, the PTFE dispersion is carried by the plasma stream 74 toward the cutting edge 56. By directing the plasma stream 74 toward the cutting edge 56 and introducing the fluid stream 80 into the plasma stream 74, the blade coating system 68 may simultaneously plasma treat the cutting edge 56 while depositing the PTFE solids of the dispersion onto the cutting edge 56 to form the coating 66. In the context of the present disclosure the term “simultaneously” includes steps occurring in rapid succession, e.g. plasma treatment immediately followed by solids deposition. In various embodiments, however, application of the plasma stream 74 to the cutting edge 56 in step 806 may initially be performed without the introduction of the fluid stream 80 in order to pretreat the cutting edge 56. After pretreatment of the cutting edge 56, the fluid stream 80 may subsequently be introduced to the plasma stream 74 to deposit the PTFE solids on the cutting edge 56.

By spraying the PTFE dispersion into the plasma stream 74, the particle size of the PTFE dispersion directed toward the cutting edge 56 may be reduced, in comparison to conventional methods of directly spraying a PTFE coating material onto a razor blade cutting edge. Further, the plasma stream 74 may heat both the PTFE dispersion and the cutting edge 56, providing a light sintering effect which improves initial bonding between the PTFE solids and the cutting edge 56 and allows the PTFE solids to more readily concentrate proximate the tip end 42 of the cutting edge 56, and assisting evaporation of the carrier fluid of the dispersion. Accordingly, aspects of the present disclosure may result in improved bonding between the PTFE solids and the cutting edge 56 and, therefore, a very thin PTFE coating 66 layer (e.g., a “monolayer”) which is substantially free of voids. A cutting edge having a coating that is free of voids is desirable (e.g., a void free coating is understood to provide a better shaving experience). The improved bonding between the PTFE solids and the cutting edge 56 may additionally require a significantly reduced flow rate of the PTFE dispersion from the spray nozzle 78, in comparison to conventional methods of directly spraying a PTFE coating material onto a razor blade cutting edge. As a result, the quantity of expensive PTFE dispersion required to produce an acceptable coating 66 on a respective razor blade 36 may be significantly reduced.

In step 810, the blade coating system 68 may be moved relative to the cutting edge 56 of the razor blade 36 so that pretreating or deposition of the coating 66 material may be performed along all or substantially all of the cutting edge 56 from the first lateral end 48 to the second lateral end 50 of the razor blade 36 (see FIGS. 3-5). In various embodiments, the blade coating system 68 may include an actuation member (not shown) configured to move the plasma generator 70 and the spray nozzle 78 in one or more of an x-, y-, or z-direction relative to the cutting edge 56. In various other embodiments, the razor blades 36 may instead be moved so that the cutting edge 56 is moved through the plasma stream 74. The present disclosure is not limited to any particular process or means for moving the blade coating system 68 relative to the cutting edge 56 of the razor blades 36.

In various embodiments, the heat from the plasma stream 74 in step 808 may be sufficient to sinter the PTFE solids and form the coating 66 on the cutting edge 56. Accordingly, a separate sintering step may not be necessary for forming the coating 66. However, in various other embodiments an independent sintering step may be used to form the coating 66. In step 812, the razor blades 36, including the PTFE solids deposited on the cutting edge 56, may be subjected to a thermal sintering process. Sintering the razor blades 36 may include heating the razor blades 36 and PTFE solids to a predetermined temperature for a period of time adequate for the PTFE solids to fuse together and to adhere to the cutting edge 56.

### EXAMPLE

In an exemplary process, plasma equipment provided by PLASMATREAT GmbH was utilized. The equipment included a model FG5001 plasma generator 70 remotely connected to a model PFW-10 plasma nozzle 72. A plasma stream 74 was generated from compressed ambient air at 1.2 bar. The plasma generator was set to 21 kHz frequency, 260V, 100% duty cycle. A fluid stream 80 was provided from a spray nozzle 78 of model OFT-AGR 09, with nozzle 0,3 provided by Reiter GmbH. Spraying parameters were horn air pressure 0.1bar, atomizing air pressure 1.0bar. The fluid of the fluid stream was the DYNEON PTFE, further diluted to 2% solids, as previously mentioned, at a flow rate 100 ml/hour. The plasma nozzle 72 was positioned at a distance D2 of 12 mm from the tip end 42 of the cutting edge 56, and the plasma nozzle 72 was arranged such that the plasma stream axis 76 of the plasma nozzle 72 was aligned with and substantially parallel to the center plane 64 of the razor blade 36 being treated. The spray nozzle 78 was then positioned relative to the plasma nozzle 72 such that intersection 65 is a distance D3 of 11.4 mm from the plasma nozzle 72 and at a distance D1 about 18 mm and at angle A1 of 40 degrees. The plasma stream 74 containing the fluid stream 80 had a width 4 mm. The plasma nozzle 72 was moved at an effective linear speed 125 mm/s relative to, and along the cutting edge 56 of the razor blade 36. The razor blade 36 thus coated with PTFE was then sintered to complete the PTFE coating process. The coated razor blades 36 were assembled into razor cartridges 20. In a sequential monadic shave test, having a control of identical cartridges, except having blades treated by the process of WO2020/081763, razor cartridges 20 having razor blades 36 treated according to the exemplary process were found to be significantly preferred (at 95% LOC) for less pulling and tugging, better glide and comfort, and no First Shave Effect.

Advantages of this method are as follows. By spraying the PTFE dispersion into the plasma stream 74, the particle size of the PTFE in the dispersion is further reduced relative to the dispersion as provided, i.e. the particle size is finer. The plasma stream 74 cleans, pre-treats and activates the cutting edge 56. The plasma stream 74 causes partial melting of the PTFE particles which improves adhesion of the PTFE to the cutting edge 56 and effectively partially pre-sinters the PTFE. Since the PTFE dispersion enters the plasma stream 74 close to the cutting edge 56 it does not undergo excessive thermal degradation. The resultant PTFE coating is thinner than known coatings without requiring any post-processing operations to e.g. chemically or mechanically thin a coating. The First Shave Effect is eliminated. Since the applied coating is thinner than known coatings (as applied), the unit consumption of the PTFE dispersion (e.g. the DYNEON or DRYFILM materials previously described) is 1/20 or less than that of the prior art processes. The method is not necessarily performed in any vacuum chamber or pressure vessel.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Accordingly, the present disclosure is not to be restricted except in light of the attached claims and their equivalents.

1. A method of applying a coating of a fluoropolymer to a cutting edge of a blade, the method comprising:
providing the blade having the cutting edge including a tip end, a first facet, and a second facet, the first facet and the second facet adjacent the tip end;
generating a plasma stream and directing the plasma stream towards the cutting edge; and
introducing a fluid stream containing a dispersion including the fluoropolymer into the plasma stream, thereby simultaneously plasma treating the cutting edge and depositing solids of the dispersion onto the cutting edge.

2. The method of claim 1, further comprising sintering the blade to cause the deposited solids to form the coating of the fluoropolymer on the cutting edge.

3. The method of claim 1, wherein the cutting edge defines a center plane, the method further including positioning a plasma nozzle generally at the center plane and generating the plasma stream with the plasma nozzle such that the plasma stream is directed along the center plane.

4. The method of claim 1, wherein the cutting edge defines a center plane, the method further including positioning a plasma nozzle so that the plasma nozzle is angularly offset from the center plane and generating the plasma stream with the plasma nozzle such that the plasma stream is directed towards the first facet.

5. The method of claim 4, further comprising positioning a second plasma nozzle so that the second plasma nozzle is angularly offset from the center plane and opposite the center plane from the plasma nozzle and generating a second plasma stream with the second plasma nozzle such that the second plasma stream of the second plasma nozzle is directed towards the second facet.

6. The method of claim 1, wherein the fluoropolymer is polytetrafluoroethylene.

7. The method of claim 6, wherein the dispersion is an aqueous dispersion and solids of the polytetrafluoroethylene comprise between 1% and 2% of the dispersion.

8. The method of claim 1, wherein the plasma stream is atmospheric plasma.

9. The method of claim 1, wherein the blade is a razor blade.

10. A blade coating system for applying a coating of a fluoropolymer to a cutting edge of a blade, the blade coating system comprising:
at least one plasma nozzle including a plasma nozzle and configured to direct a plasma stream outward from the plasma nozzle along a plasma stream axis toward the cutting edge of the blade; and
at least one spray nozzle mounted to the at least one plasma nozzle and configured to discharge a fluid stream containing a dispersion including the fluoropolymer into the plasma stream along a fluid stream axis.
